(19) United States
(12) Patent Application Publication
(10) Pub. No.: US 2014/0354063 A1
(43) Pub. Date: Dec. 4, 2014

(54) TRACKING SURFACE FOR DETERMINING OPTIMAL CHARGING POSITION

(71) Applicant: DvineWave Inc., San Ramon, CA (US)

(72) Inventors: Michael A. Leabman, San Ramon, CA (US); Gregory Scott Brewer, Livermore, CA (US)

(21) Appl. No.: 13/908,760

(22) Filed: Jun. 3, 2013

(51) Int. Cl. H02J 7/02

(52) U.S. Cl. CPC H02J 7/025
USPC 307/104

(57) ABSTRACT

The present disclosure describes a methodology for tracking position and orientation of one or more electronic devices, which may receive charge through wireless power transmission based on pocket-forming. This methodology may include one transmitter and at least one or more receivers, being the transmitter the source of energy and the receiver the device that is desired to charge or power. The transmitter may identify and locate the device to which the receiver is connected for subsequently charge and/or charge it. In order to increase charging and/or powering of electronic devices, a plurality of sensors may provide information determining the optimal position and/or orientation aimed to receive charge and/or power at the maximum available efficiency.

### CROSS-REFERENCES TO RELATED APPLICATIONS

The present disclosure is related to U.S. Non-Provisional patent application Ser. No. 13/891,399 filed on May 10, 2013, entitled “Receivers For Wireless Power Transmission”; Ser. No. 13/891,430 filed on May 10, 2013, entitled “Methodology for Pocket-forming”; and Ser. No. 13/891,445 filed on May 10, 2013, entitled “Transmitters For Wireless Power Transmission”, invented by Michael A. Leabman, the entire contents of which are incorporated herein by these references.

### FIELD OF INVENTION

The present disclosure relates to electronic transmitters, and more particularly to transmitters for wireless power transmission.

### BACKGROUND OF THE INVENTION

Electronic devices such as laptop computers, smartphones, portable gaming devices, tablets and so forth may require power for performing their intended functions. This may require having to charge electronic equipment at least once a day, or in high-demand electronic devices more than once a day. Such an activity may be tedious and may represent a burden to users. For example, a user may be required to carry chargers in case his electronic equipment is lacking power. In addition, users have to find available power sources to connect to. Lastly, users must plugin to a wall or other power supply to be able to charge his or her electronic device. However, such an activity may render electronic devices inoperable during charging. Current solutions to this problem may include inductive pads which may employ magnetic induction or resonating coils. Nevertheless, such a solution may still require that electronic devices may have to be placed in a specific place for powering. Thus, electronic devices during charging may not be portable. For the foregoing reasons, there is a need for a wireless power transmission system where electronic devices may be powered without requiring extra chargers or plugs, and where the mobility and portability of electronic devices may not be compromised. Such system may charge and/or power electronic devices with an efficiency that may depend on distance, obstacles, temperature, among others. Thus, a system for tracking and positioning electronic devices is required, such system may locate optimal orientation for charging and/or powering devices at a maximum available efficiency.

### SUMMARY OF THE INVENTION

The present disclosure provides a system for determining the optimal position and orientation of an electronic devices through a plurality of sensors which may provide information to a software that may notify the user in order to change position and orientation for receiving charge and/or power at the maximum available efficiency.

System for tracking position and orientation may include one or more flowcharts which may be included into an algorithm or group of instructions, which may be used by a processor, CPU, among others, for determining where an electronic device receives charge and/or power at the maximum available efficiency. Thus, a high flexibility may be allow for charging and/or powering a plurality of electronic devices because, wireless power transmission may be employed with a maximum available efficiency in variety of applications, regardless obstacles and interferences.

### BRIEF DESCRIPTION OF THE DRAWINGS

Non-limiting embodiments of the present disclosure are described by way of example with reference to the accompanying figures which are schematic and may not be drawn to scale. Unless indicated as representing the background art, the figures represent aspects of the disclosure.

FIG. 1 illustrates a wireless power transmission example situation using pocket-forming.

FIG. 2 illustrates a tracking and positioning flowchart, which may be employed by an algorithm in a controller, CPU, processor, computer, among others, for determining the optimal position and orientation of an electronic device which may receive charge and/or power through wireless power transmission.

FIG. 3A illustrates wireless power transmission, where a cellphones receives charge and/or power at low efficiency.

FIG. 3B illustrates wireless power transmission, where a cellphones receives charge and/or power at low efficiency.

### DETAILED DESCRIPTION OF THE DRAWINGS

“Pocket-forming” may refer to generating two or more RF waves which converge in 3-d space, forming controlled constructive and destructive interference patterns.

“Pockets of energy” may refer to areas or regions of space where energy or power may accumulate in the form of constructive interference patterns of RF waves.

“Null-space” may refer to areas or regions of space where pockets of energy do not form because of destructive interference patterns of RF waves.

“Transmitter” may refer to a device, including a chip which may generate two or more RF signals, at least one RF signal being phase shifted and gain adjusted with respect to other RF signals, substantially all of which pass through one or more RF antenna such that focused RF signals are directed to a target.

“Receiver” may refer to a device including at least one antenna element, at least one rectifying circuit and at least one power converter, which may utilize pockets of energy for powering, or charging an electronic device.

“Adaptive pocket-forming” may refer to dynamically adjusting pocket-forming to regulate power on one or more targeted receivers.

### DESCRIPTION OF THE DRAWINGS

In the following detailed description, reference is made to the accompanying drawings, which form a part hereof. In the drawings, which are not to scale or to proportion, similar symbols typically identify similar components, unless context dictates Otherwise. The illustrative embodiments described in the detailed description, drawings and claims, are not meant to be limiting. Other embodiments may be used and/or and other changes may be made without departing from the spirit or scope of the present disclosure.

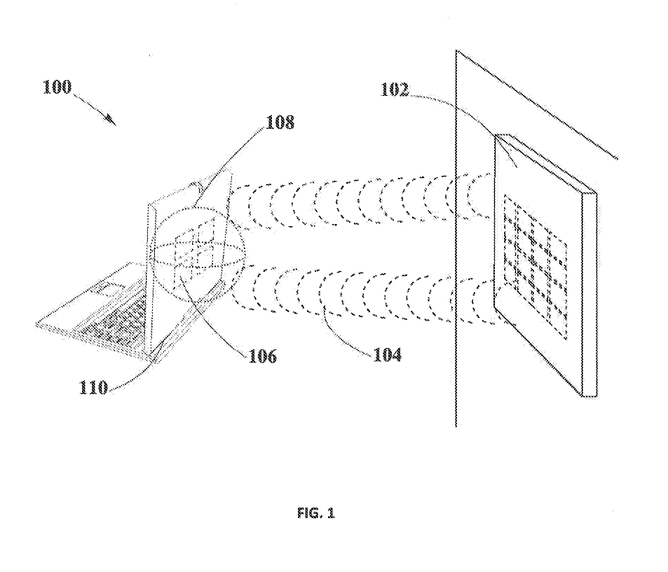

FIG. 1 illustrates wireless power transmission 100 using pocket-forming. A transmitter 102 may transmit controlled Radio RF waves 104 which may converge in 3-d space. These Radio frequencies (RF) waves may be controlled through phase and/or relative amplitude adjustments to form constructive and destructive interference patterns (pocket-forming). Pockets of energy 108 may be formed at constructive interference patterns and can be 3-dimensional in shape whereas null-spaces may be generated at destructive interference patterns. A receiver 106 may then utilize pockets of energy 108 produced by pocket-forming for charging or powering an electronic device, for example a laptop computer 110 and thus effectively providing wireless power transmission. In other situations there can be multiple transmitters 102 and/or multiple receivers 106 for powering various electronic equipment for example smartphones, tablets, music players, toys and others at the same time. In other embodiments, adaptive pocket-forming may be used to regulate power on electronic devices.

The method of wireless power transmission begins by generating two or more RF waves from a transmitter with at least two RF transmit antenna. The transmitter forms controlled constructive and destructive interference patterns from the generated RF waves. The system accumulates the energy or power in the form of constructive interference patterns from the RF waves to form pockets of energy. The transmitter assists in converging the pockets of energy in 3-d space to a targeted electronic device. Whereby the converged pockets of energy are collected by a receiver connected to the electronic device with at least one antenna for powering or charging the targeted electronic device from the pockets of energy. The electronic devices are typically a cellphone, iPad, iPhone, tablet, an Android device or other similar electronic device operating by charging a battery associated with the device.

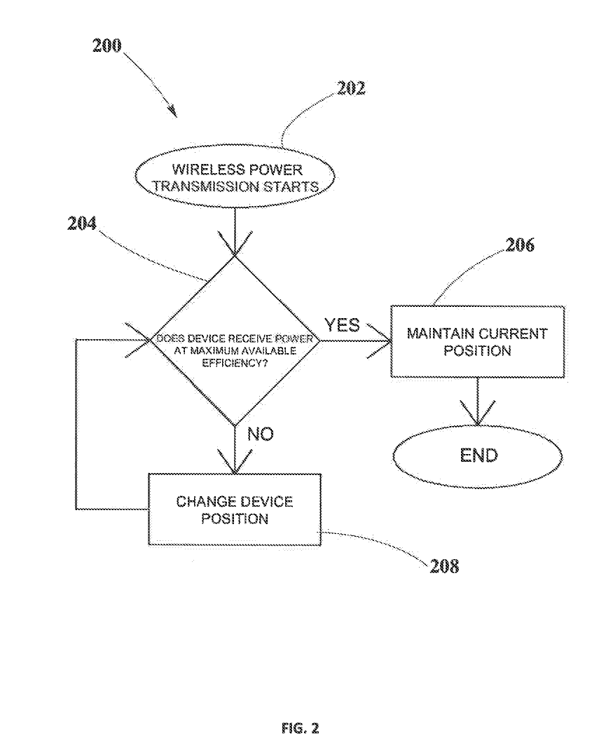

FIG. 2 illustrates tracking and positioning flowchart 200, which may be employed by an algorithm in a controller, CPU, processor, computer among others, for determining the optimal position and orientation of an electronic device which may receive power and/or charge through wireless power transmission 100.

In order to achieve the optimal efficiency, electronic device may use a variety of sensors for determining the voltage level in battery and/or the power level received when wireless power transmission starts 202. Such sensors may indicate whether the device is receiving power at the maximum available efficiency 204. Maximum available efficiency may depend on distance from transmitter, obstacles, temperature, among others. If the device is receiving power at maximum available efficiency, then an application, software or program installed on the electronic device and/or in the receiver 106 may aware and/or notify user to maintain current position 206. Moreover, if the device is receiving power at a lower efficiency than the maximum available efficiency, then software or program may use a variety of sensors for tracking and determining the optimal position of electronic device in relation with transmitter 102 position and orientation. Sensors may include accelerometers, infrared, GPS, among others. Furthermore, a communication reciprocity may be used by the communication module for tracking and positioning. Communication module may include and combine Bluetooth technology, infrared communication, WI-FI, FM radio among others. By comparing voltage level and/or power received in each position and/or orientation of electronic device, the software and/or program may notify and/or guide user to change device position 208 for looking the optimal position and/or orientation.

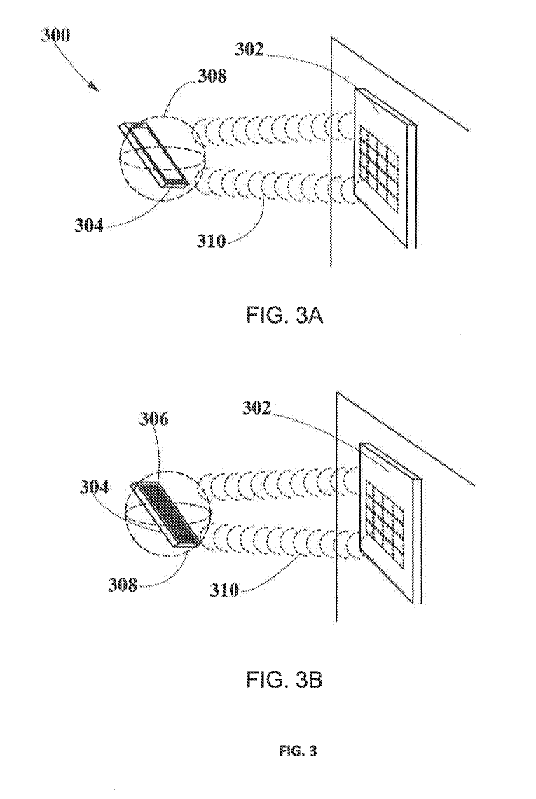

FIG. 3 illustrates wireless power transmission 300, where a transmitter 302 may produce pocket-forming over plurality of cellphone 304. As depicted in FIG. 3A, wireless power transmission 300 may charge and/or power cellphone 304 at a low efficiency because antennas 306 on the receiver 106 may be faced to the same direction of the RF waves 310, thus pocket of energy 308 may provide less charge and/or power to antennas 306. As shown in FIG. 3B By turning cellphone 304 180° degrees, antennas 306 may receive power at a higher efficiency, such efficiency may be achieved due the antennas 306 orientation, which may be faced in the opposite direction of RF waves 310.

While various aspects and embodiments have been disclosed herein, other aspects and embodiments may be contemplated. The various aspects and embodiments disclosed herein are for purposes of illustration and are not intended to be limiting, with the true scope and spirit being indicated by the following claims.

Having this described the invention, we claim:

1. A method for transmitting wireless power, comprising:
generating two or more RF waves from a transmitter with at least two RF transmit antenna;
forming controlled constructive and destructive interference patterns from the generated RF waves;
accumulating energy or power in the form of constructive interference patterns from the RF waves to form pockets of energy;
converging the pockets of energy in 3-d space to a targeted electronic device;
sensing the converging pockets of energy for determining the power level and efficiency received by the targeted electronic device; and
maintaining or changing the electronic device position for maximizing the efficiency of receiving the converged pockets of energy in a receiver connected to the electronic device with at least one antenna for powering the targeted electronic device from the pockets of energy.

2. The method for transmitting wireless power of claim 1, wherein the sensing is accomplished through accelerometers, infrared or UPS sensor circuits for tracking and positioning the electronic device.

3. The method for transmitting wireless power of claim 1, further comprising communicating circuitry in the transmitter and receiver for comparing the voltage level and power received to guide user for changing the device position to optimize position or orientation of the device for reception of the pockets of energy.

4. The method for transmitting wireless power of claim 3, wherein the communicating circuitry uses Bluetooth, infrared, Wi-Fi or FM radio signals for communication between the transmitter and the receiver.

5. The method for transmitting wireless power of claim 1, further comprising computing instructions for processing the sensed signals representing the power level and efficiency of the wireless transmitted power from the received pockets of energy.

6. A system for transmitting wireless power, comprising:
a transmitter generating pockets of energy;
a receiver electrically connected to at least one electronic device for receiving the pockets of energy;
a communication network on the transmitter and receiver controlled by a processor for determining a battery and power level of the electronic device and for tracking and positioning the electronic device to the optimal position or orientation for maximizing pockets of energy reception.

7. The system for transmitting wireless power of claim 6, wherein the transmitter generates two or more RF waves from at least two RF transmit antennae to create constructive interference patterns from the RF waves to form the pockets of energy.

8. The system for transmitting wireless power of claim 6, wherein the receiver or electronic device includes sensors generating signals representing the battery level, power level, position and orientation of the device for feeding a processor including a set of instructions to maximize the efficiency for charging at least one electronic device from the sensor signals.

9. The system for transmitting wireless power of claim 8, wherein the generated pockets of energy are received by a plurality of electronic devices at a higher efficiency due to antennas orientation directed by the processor in response to the sensor signals.

10. The system for transmitting wireless power of claim 6, wherein the processor includes predetermined instructions for determining the optimal position and orientation of the electronic device to receive the pockets of energy for charging the device.

11. A system for transmitting wireless power, comprising:
a transmitter for generating two or more RF waves having at least two RF transmit antenna to form controlled constructive and destructive interference patterns from the generated RF waves;
a processor within the transmitter controlling the constructive interference patterns from the generated RF waves to form pockets of energy;
a receiver with at least one antenna for accumulating the pockets of energy converging in 3-d space to a targeted electronic device;
a communication network connected to transmitter and receiver for utilizing the respective antennas for broadcasting signals from one or more sensors located on the transmitter, receiver or the electronic device for determining the power level and efficiency of the charging power received by the targeted electronic device; and
wherein efficiency of the converged pockets of energy processed by the receiver connected to the electronic device are directly related to the sensor signals for determining the optimal position and orientation of the electronic device being charged.

12. The system for transmitting wireless power of claim 11, wherein the processor includes instructions for processing the sensor signals to determine the tracking and positioning of the electronic device.

13. The system for transmitting wireless power of claim 11, wherein the communication network includes Bluetooth, infrared, Wi-Fi or FM radio signals.

14. The system for transmitting wireless power of claim 11, wherein the sensors are accelerometers, infrared, proximity, motion detector or GPS circuits.

15. The system for transmitting wireless power of claim 11, wherein the sensors provide information concerning a plurality of electronic devices ready to be charged.

16. The system for transmitting wireless power of claim 11, wherein the electronic device is a cellphone, iPad, iPod, Tablet, iPhone, an Android device or other electronic device for charging a battery associated with the device.

17. The system for transmitting wireless power of claim 11, wherein the transmitter produces pocket-forming over a plurality of electronic devices.

18. The system for transmitting wireless power of claim 11, wherein the processor is a computer, an ASIC, a controller, microprocessor or other similar device that is capable of processing instructions.

19. The system for transmitting wireless power of claim 11, wherein the transmitter creates the pocket-forming pockets of energy to converge in 3-D space in a direction related to the sensor signals representing the tracking and orientation of the electronic device.

20. The system for transmitting wireless power of claim 11, wherein the processor dynamically adjusts the pocket-forming to regulate power on one or more targeted electronic devices.
